(19) United States
(12) Patent Application Publication
(10) Pub. No.: US 2026/0369929 A1
(43) Pub. Date: Nov. 19, 2026

(54) CONNECTOR MATING STRUCTURE

(71) Applicant: YAZAKI CORPORATION, Tokyo (JP)

(72) Inventors: Tetsuya Watanabe, Makinohara-shi (JP); Ryu Katagiri, Fujieda-shi (JP)

(21) Appl. No.: 19/651,643

(22) Filed: Apr. 18, 2026

(30) Foreign Application Priority Data
May 14, 2025 (JP) 2025-080873

(51) Int. Cl. H01R 13/627; H01R 13/64

(52) U.S. Cl. CPC H01R 13/6275; H01R 13/64

(57) ABSTRACT

A connector mating structure 10 includes a first connector 1, in which a CPA 5 is attached to a first housing 2, and a second connector 6. The first housing 2 includes a main body portion 20 accommodating terminals, a housing lock 21 that extends cantilevered forward from an upper surface of the main body portion 20, and a lock protection portion 22. A pair of ribs 24 extending in a movement direction of the CPA 5 is provided on an upper wall 22b of the lock protection portion 22. The pair of ribs 24 press the CPA 5 toward the main body portion 20 in a state where, after completion of mating between the first connector 1 and the second connector 6, the CPA 5 is positioned at the mating assurance position to lock to the housing lock 21.

### TECHNICAL FIELD

The present invention relates to a connector mating structure including a mating assurance member.

### BACKGROUND

A connector including a mating assurance member that is configured to be attached to a housing, is immovable before completion of mating with a counterpart connector, and becomes movable after completion of mating is known (see, for example, Patent Document 1). The mating assurance member is also referred to as a Connector Position Assurance (CPA). Hereinafter, in the present specification, the mating assurance member will be referred to as a CPA.

### Related Art

### Patent Document

Patent Document 1: JP2023117674 A

### SUMMARY OF THE INVENTION

### Problem to be Solved by the Invention

In a conventional connector mating structure including a CPA, clearance between components may cause looseness (play) in the CPA when the connectors are in a mating-completed state. When such a connector mating structure is applied to a vehicle, the above-described looseness may generate abnormal noise during vehicle travel, and therefore there has been room for improvement.

Accordingly, it is an object of the present invention to provide a connector mating structure including a CPA that alleviates looseness (play) of the CPA when the connectors are in a mating-completed state.

### Solution to Problem

The present invention relates to a connector mating structure comprising:
a first connector and a second connector configured to mate with each other,
wherein the first connector includes:
   a first housing; and
   a mating assurance member that is configured to be attached to the first housing, the mating assurance member being immovable before completion of mating between the first connector and the second connector, the mating assurance member being movable forward after completion of the mating,
wherein the first housing includes:
   a main body portion accommodating terminals;
   a housing lock that extends cantilevered forward from an upper surface of the main body portion; and
   a lock protection portion including a pair of side walls arranged on left and right sides of the housing lock and an upper wall that positions the housing lock between the upper wall and the main body portion,
   wherein the mating assurance member is accommodated between the pair of side walls and between the upper wall and the housing lock,
   the housing lock is configured to lock to the second connector having mated with the first connector and to the mating assurance member having moved forward,
   a rib extending in a front-and-rear direction, which is a movement direction of the mating assurance member, is provided on the upper wall, and
   when the mating assurance member has moved forward and has locked to the housing lock, the rib presses the mating assurance member toward the main body portion.

### Advantageous Effects of the Invention

According to the present invention, the occurrence of looseness in the CPA in the mating-completed state in which the first connector and the second connector are mated can be alleviated.

### BRIEF DESCRIPTION OF THE DRAWINGS

FIG. 1 is a view illustrating a first connector according to a first embodiment of the present invention.

FIG. 2 is a view illustrating a second connector to be mated with the first connector of FIG. 1.

FIG. 3 is an exploded view of the first connector of FIG. 1.

FIG. 4 is a front view of the first housing of FIG. 3.

FIG. 5 is a cross-sectional view taken along line A-A in FIG. 4.

FIG. 6 is a cross-sectional view taken along line B-B in FIG. 4.

FIG. 7 is a view illustrating a state in which the first connector of FIG. 1 and the second connector of FIG. 2 are completely mated.

FIG. 8 is a cross-sectional view taken along line C-C in FIG. 7.

FIG. 9 is a cross-sectional view taken along line D-D in FIG. 7.

FIG. 10 is a view illustrating a state in which the CPA of FIG. 8 has moved forward.

FIG. 11 is a view illustrating a state in which the CPA of FIG. 10 has further moved forward and is locked to a housing lock of the first housing.

FIG. 12 is a cross-sectional view taken along line E-E in FIG. 11.

FIG. 13 is a cross-sectional view taken along line F-F in FIG. 11.

FIG. 14 is a view illustrating a first connector according to a second embodiment of the present invention.

FIG. 15 is an exploded view of the first connector of FIG. 14.

FIG. 16 is a front view of the first housing of FIG. 15.

FIG. 17 is a cross-sectional view taken along line G-G in FIG. 16.

FIG. 18 is a cross-sectional view taken along line H-H in FIG. 16.

FIG. 19 is a view illustrating a state before the first connector of FIG. 14 and the second connector of FIG. 2 are completely mated.

FIG. 20 is a cross-sectional view taken along line I-I in FIG. 19.

FIG. 21 is a cross-sectional view taken along line J-J in FIG. 19.

FIG. 22 is a cross-sectional view taken along line K-K in FIG. 19.

FIG. 23 is a view illustrating a state in which the first connector and the second connector of FIG. 19 are completely mated and the CPA is positioned at a mating assurance position.

FIG. 24 is a cross-sectional view taken along line M-M in FIG. 23.

FIG. 25 is a cross-sectional view taken along line L-L in FIG. 23.

### DETAILED DESCRIPTION OF THE EXEMPLARY EMBODIMENT

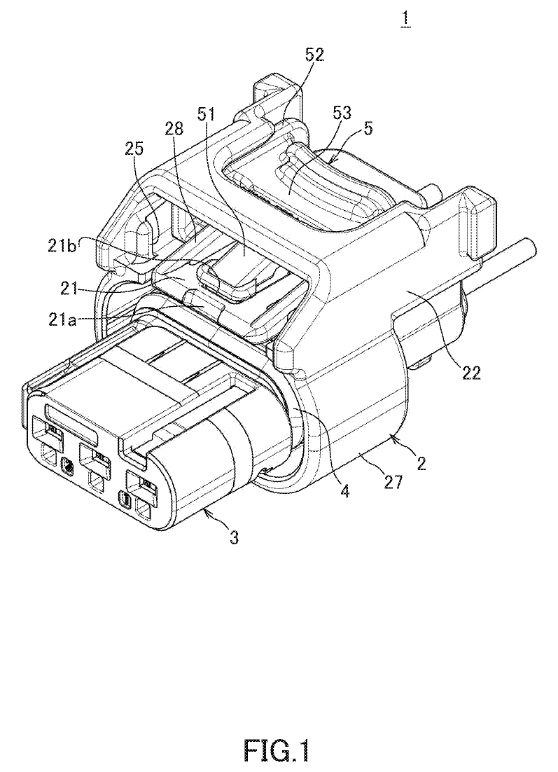

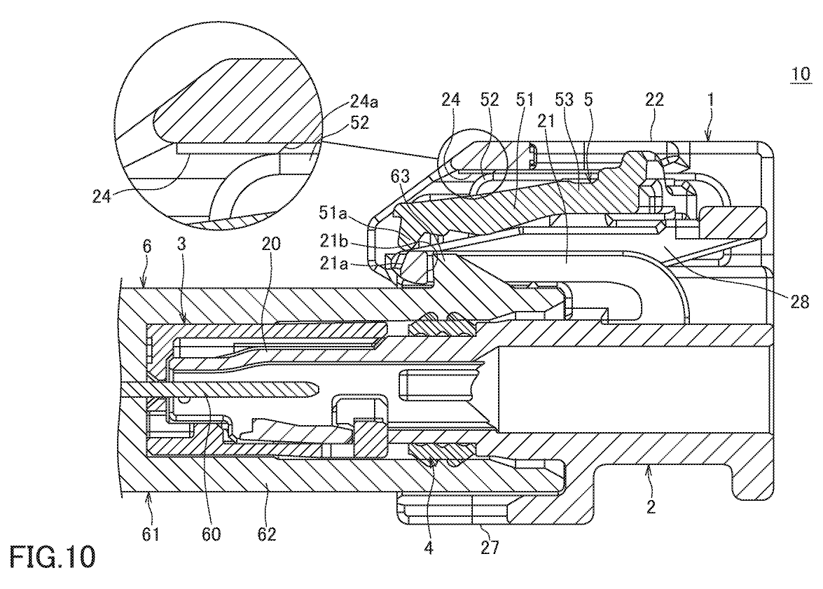

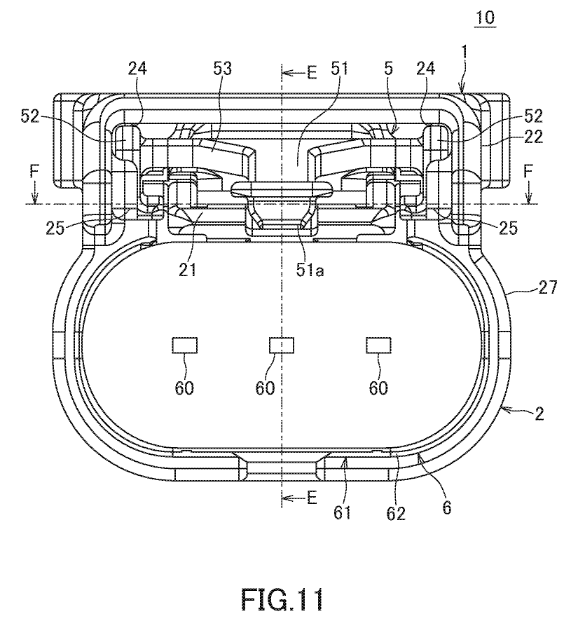

A "connector mating structure" according to a first embodiment of the present invention will be described with reference to FIGS. 1-13.

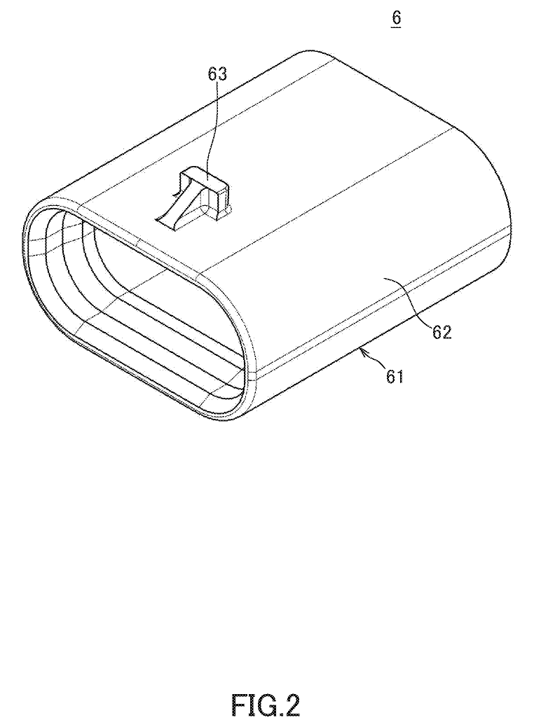

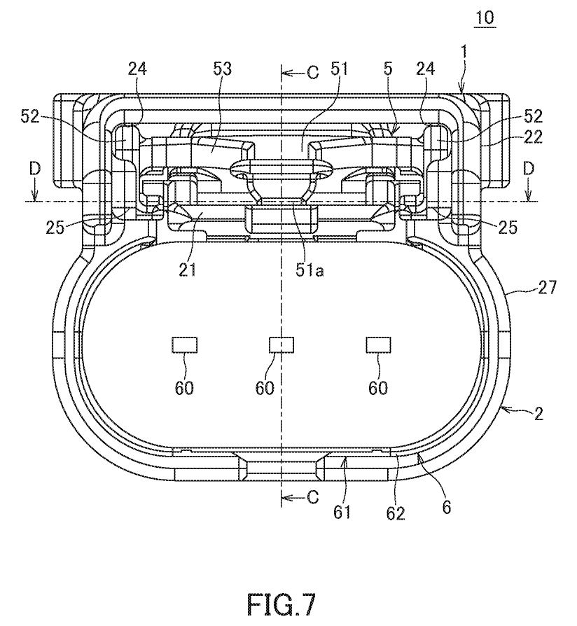

The connector mating structure 10 illustrated in FIGS. 7-13 includes a first connector 1 (illustrated in FIG. 1) and a second connector 6 (illustrated in FIG. 2), which are configured to mate with each other.

In the present specification, a side of the first connector 1 that faces the second connector 6 in the mating direction with the second connector 6 is defined as a "front", and the opposite side is defined as a "rear". A side on which the CPA 5, described later, is attached, in a direction perpendicular to the mating direction, is defined as a "top", and the opposite side is defined as a "bottom". One side in a direction perpendicular to both the mating direction and the vertical direction is defined as "left", and the opposite side as the "right". Similarly, the side of the second connector 6 that faces the first connector 1 in the mating direction with the first connector 1 is defined as a "front", and the opposite side is defined as a "rear". The terms indicating these directions are used merely for convenience in describing the present invention and are not required to correspond to actual directions.

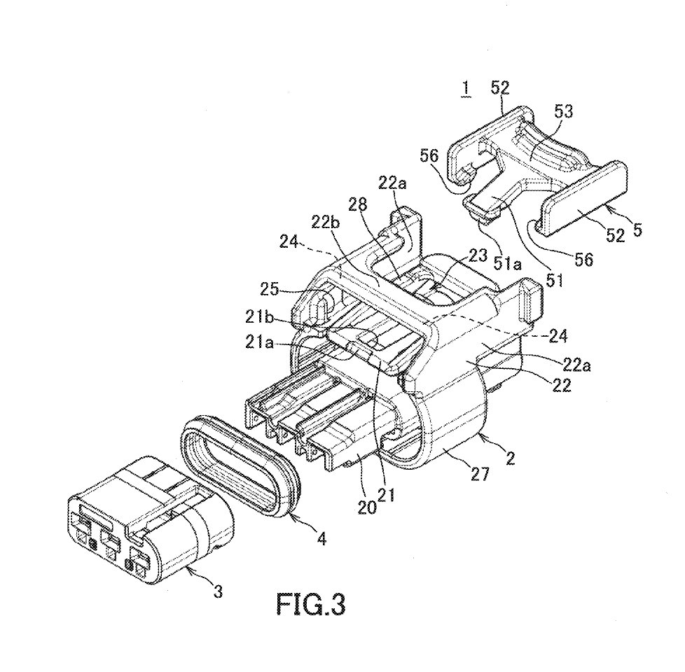

As illustrated in FIG. 3, the first connector 1 includes a plurality of female terminals (not illustrated), a first housing 2 that holds the plurality of female terminals, a packing 4, a front retainer 3, and a CPA (mating assurance member) 5.

As illustrated in FIGS. 2, 7-13, the second connector 6 includes a plurality of male terminals 60 and a second housing 61 that holds the plurality of male terminals 60. The second housing 61 is made of an insulating synthetic resin. The second housing 61 surrounds the plurality of male terminals 60 and integrally includes a cylindrical portion 62 that is open at the front and a lock protrusion 63 provided on the upper surface of the cylindrical portion 62.

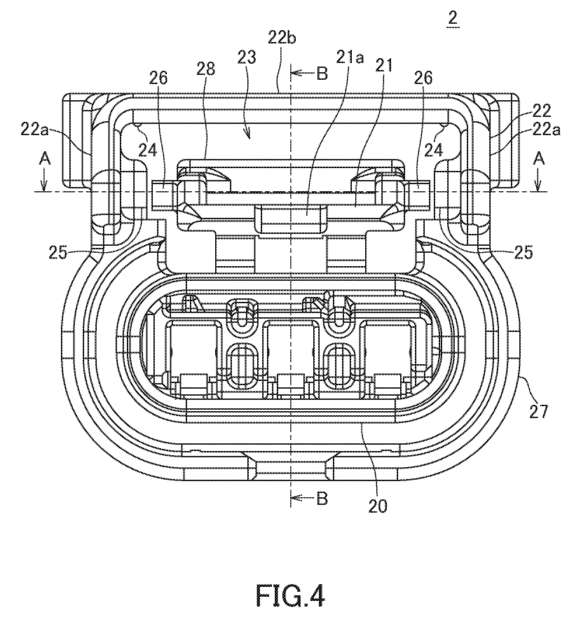

The first housing 2 is made of an insulating synthetic resin. As illustrated in FIGS. 4-6, the first housing 2 integrally includes a main body portion 20, a housing lock 21, a release arm 28, a hood portion 27, and a lock protection portion 22.

The main body portion 20 is a portion that accommodates the female terminals (not illustrated), and three terminal accommodating portions extending in the front-and-rear direction are provided side by side in the left-right direction. The front retainer 3 is mounted on the front end portion of the main body portion 20 to prevent the female terminals from coming out. The main body portion 20, together with the front retainer 3, is inserted into the cylindrical portion 62 of the second connector 6.

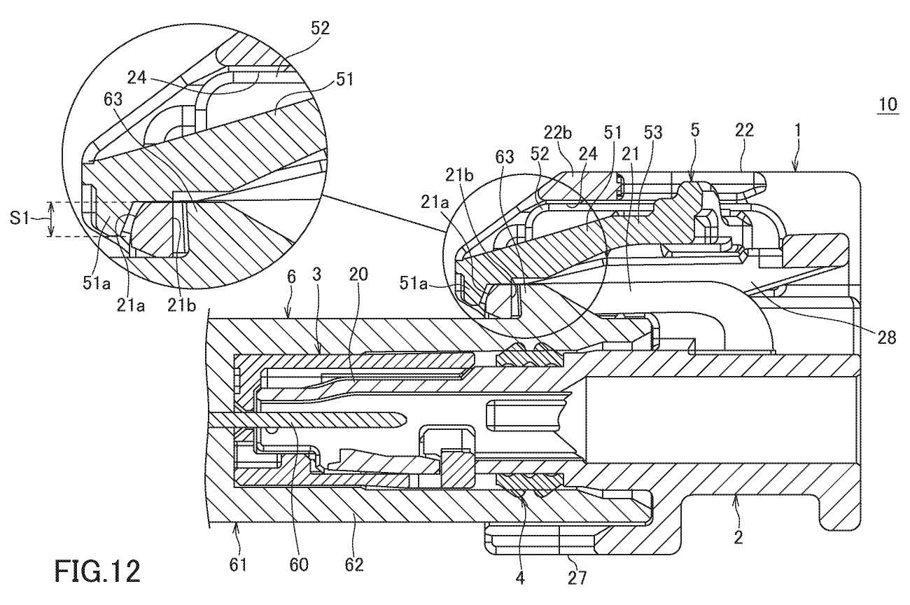

The packing 4 is formed in an annular shape and is mounted on the outer peripheral portion of the main body portion 20. As illustrated in FIG. 12, the packing 4 seals the space between the main body portion 20 and the cylindrical portion 62 in the mating-completed state in which the first connector 1 and the second connector 6 are mated.

The housing lock 21 extends cantilevered forward from the upper surface of the main body portion 20. The housing lock 21 is formed in a frame shape having an opening 21b. A notch 21a is formed at the tip of the housing lock 21.

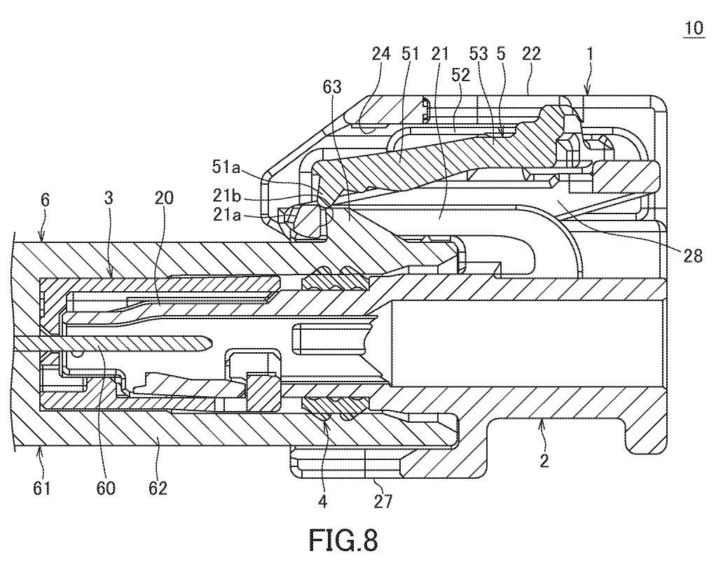

Before the mating of the first connector 1 and the second connector 6 is completed, the housing lock 21 temporarily locks to the CPA 5, as illustrated in FIG. 1, preventing the CPA 5 from moving forward. When the first connector 1 and the second connector 6 are mated, the lock protrusion 63 of the second connector 6 fits in and locks to the opening 21b of the housing lock 21, as illustrated in FIG. 8. This locking maintains the mated state between the first connector 1 and the second connector 6. Moreover, by the lock protrusion 63 fitting into the opening 21b, the temporary locking between the CPA 5 and the housing lock 21 is released, allowing the CPA 5 to move forward. Then, as illustrated in FIG. 12, the housing lock 21 locks to the CPA 5 after it has moved forward, preventing the CPA 5 from moving backward.

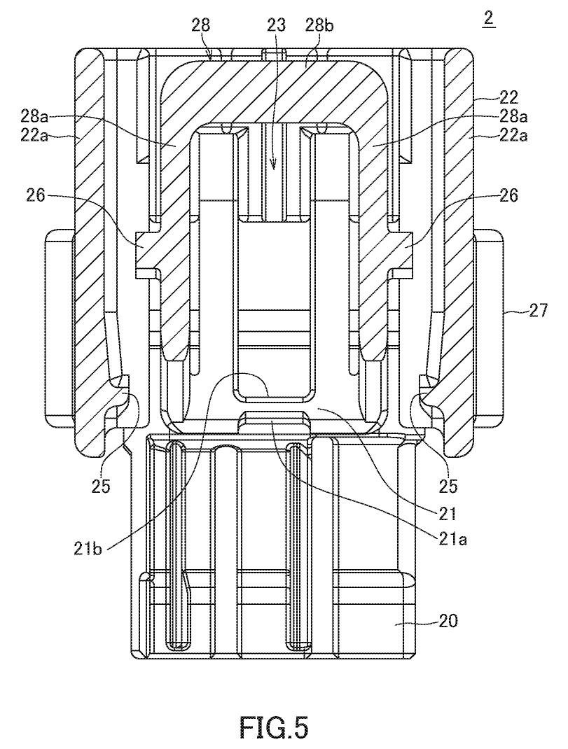

As illustrated in FIG. 5, the release arm 28 extends from both the left and right sides of the housing lock 21 toward the rear and is positioned outside the housing lock 21. Specifically, the release arm 28 includes a pair of arm portions 28a that extend along both sides of the housing lock 21 further toward the rear than the housing lock 21, and a connecting portion 28b that connects the rear ends of the pair of arm portions 28a. When the connecting portion 28b of the release arm 28 is pressed toward the main body portion 20, the front side of the housing lock 21 rises away from the main body portion 20, thereby releasing the locking between the housing lock 21 and the lock protrusion 63.

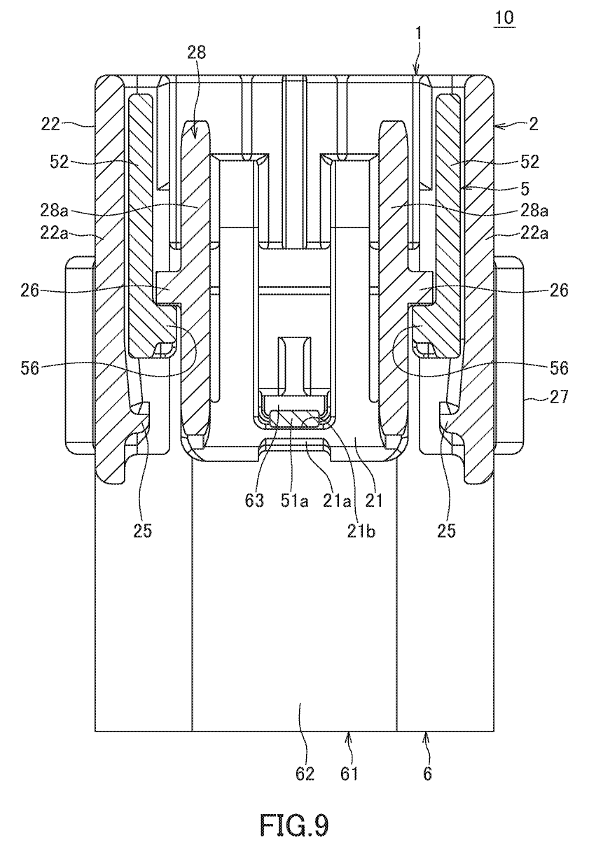

Each of the pair of arm portions 28a of the release arm 28 is provided with a protrusion 26 that projects outward in the left-right direction (toward side walls 22a, described later). Before the mating between the first connector 1 and the second connector 6 is completed, the pair of protrusions 26 temporarily lock to the CPA 5, as illustrated in FIG. 9, preventing the CPA 5 from moving backward.

The hood portion 27 is a wall provided on the outer peripheral portion of the main body portion 20 and positions the cylindrical portion 62 of the second connector 6 between the hood portion 27 and the main body portion 20. The hood portion 27 is provided so as to avoid the areas where the housing lock 21 and the release arm 28 are formed, and it is shaped in a C shape when viewed from the front.

As illustrated in FIGS. 3-4, the lock protection portion 22 includes a pair of side walls 22a and an upper wall 22b. The pair of side walls 22a extend from the hood portion 27 and are positioned on both the left and right sides of the housing lock 21 and the release arm 28. The upper wall 22b connects the pair of side walls 22a and positions the housing lock 21 and the release arm 28 between the upper wall 22b and the main body portion 20. The lock protection portion 22 surrounds the housing lock 21 and the release arm 28 from three sides, preventing unintended external forces from acting on them. The CPA 5 is accommodated in a space (hereinafter referred to as a "CPA accommodating portion") 23 that is between the pair of side walls 22a and between the upper wall 22b and the housing lock 21.

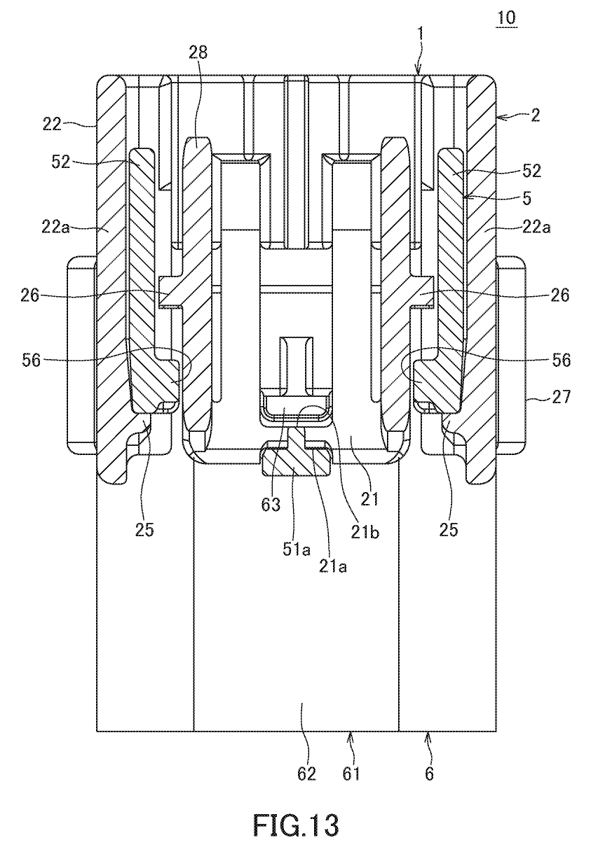

As illustrated in FIGS. 1, 4 and 5, the front end portions of the pair of side walls 22a are provided with protruding portions 25 that project inward in the left-right direction (toward the housing lock 21). After the mating of the first connector 1 and the second connector 6 is completed, the pair of protruding portions 25 abut against the CPA 5, as illustrated in FIG. 13, preventing the CPA 5 from moving forward.

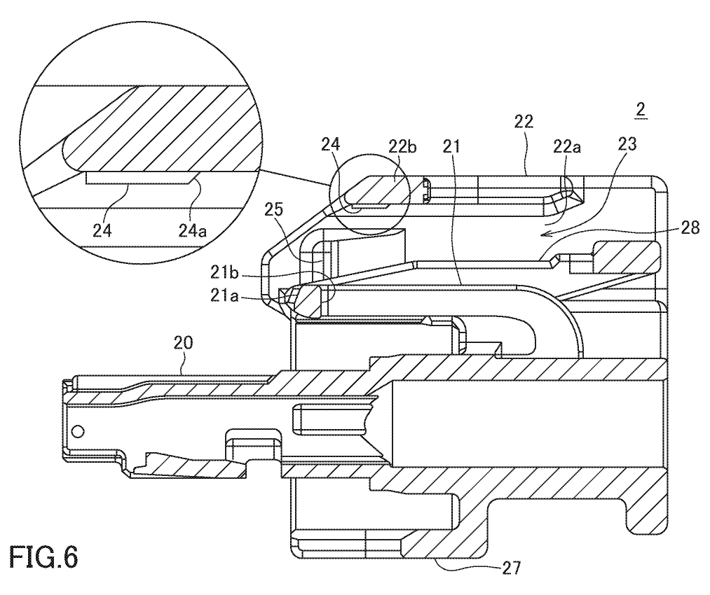

As illustrated in FIGS. 4, 6, a pair of ribs 24 extending in the front-and-rear direction, which is the moving direction of the CPA 5, are provided on the lower surface of the upper wall 22b. The pair of ribs 24 are located at the locations that are on the left and right end portions and that are on the front end portion of the upper wall 22b. A tapered portion 24a is formed at the rear end of each rib 24. Before the mating of the first connector 1 and the second connector 6 is completed, the pair of ribs 24 do not contact the CPA 5. After mating is completed, as illustrated in FIGS. 8, 10 and 12, the ribs 24 contact the CPA 5 while the CPA 5 moves forward, pressing the CPA 5 toward the main body portion 20. This alleviates looseness in the CPA 5.

The CPA 5 is attached to the first housing 2 and cannot move before the mating between the first connector 1 and the second connector 6 is completed. After mating is completed, the CPA 5 becomes movable forward. By being positioned in the mating assurance position, as illustrated in FIG. 12, the CPA 5 assures that the first connector 1 and the second connector 6 are fully mated.

The CPA 5 is made of an insulating synthetic resin. As illustrated in FIGS. 1-3, the CPA 5 includes a pair of plate portions 52 arranged on both the left and right sides of the housing lock 21 and the release arm 28, a connecting portion 53 that connects the pair of plate portions 52, and an arm 51 that extends cantilevered forward from the connecting portion 53. A downwardly protruding protrusion 51a is provided at the tip of the arm 51. Each of the pair of plate portions 52 is provided with a protrusion 56 that projects inward in the left-right direction (toward the arm 51). The pair of protrusions 56 project inward from locations that are on the front end portions and that are on the lower end portions of the plate portions 52.

The CPA 5 is inserted into the CPA accommodating portion 23 from the rear of the first housing 2 and attached to the first housing 2. Specifically, when the CPA 5 is inserted into the CPA accommodating portion 23, the pair of plate portions 52 are positioned between the pair of side walls 22a and the release arm 28, and the connecting portion 53 is positioned between the housing lock 21 and the upper wall 22b and between the release arm 28 and the upper wall 22b. Furthermore, the protrusion 51a at the tip of the arm 51 fits into the opening 21b of the housing lock 21 from above to achieve temporary locking. As a result, the CPA 5 is prevented from moving forward. In addition, the pair of protrusions 56 provided on the CPA 5 is positioned in front of the pair of protrusions 26 provided on the release arm 28 and temporarily locks to the protrusions 26. As a result, the CPA 5 is prevented from moving rearward. In this manner, the CPA 5 is attached to the first housing 2 in a non-movable state. That is, the CPA 5 is temporarily locked to the first housing 2.

When the first connector 1 and the second connector 6 are mated, the lock protrusion 63 of the second connector 6 fits into and locks to the opening 21b of the housing lock 21 from below. As a result, the protrusion 51a of the arm 51 is pushed upward and unlocks from the opening 21b of the housing lock 21, whereby the temporary locking is released and the CPA 5 becomes movable forward (see FIG. 8).

The CPA 5, whose temporary locking has been released, is pressed from the rear by an operator or the like and thereby moves forward to the mating assurance position. During this forward movement, the pair of ribs 24 respectively contact the pair of plate portions 52 and press the plate portions 52 toward the main body portion 20. Since the tapered portion 24a is provided at the rear end of each rib 24, the plate portions 52 smoothly slide under the ribs 24 without interference during movement of the CPA 5.

When the CPA 5 is positioned at the mating assurance position illustrated in FIG. 12, the protrusion 51a of the arm 51 locks to the notch 21a formed at the tip of the housing lock 21. As a result, rearward movement of the CPA 5 is prevented. Furthermore, when the CPA 5 is positioned at the mating assurance position illustrated in FIG. 12, the front end surfaces of the pair of plate portions 52 come into contact with the pair of protruding portions 25 of the first housing 2, as illustrated in FIG. 13. This prevents forward movement of the CPA 5. Moreover, the pair of ribs 24 press the pair of plate portions 52 toward the main body portion 20, thereby alleviating looseness of the CPA 5 in the vertical direction. In this manner, the CPA 5 is locked to the first housing 2 in a non-movable state (primary locking).

In this way, the connector mating structure 10 can alleviate looseness in the CPA 5 in the mating-completed state in which the first connector 1 and the second connector 6 are mated. Therefore, when the connector mating structure 10 is mounted on a vehicle, it is possible to prevent rattling of the CPA 5 caused by vehicle vibrations, thereby alleviating the generation of abnormal noises. In addition, since the ribs 24 press the plate portions 52, the CPA 5 does not tilt, and an engagement allowance S1 (see FIG. 12) between the arm 51 of the CPA 5 and the housing lock 21 is stabilized, so the engagement force between the arm 51 and the housing lock 21 can be increased. Furthermore, because the ribs 24 press the plate portions 52, the arm 51 presses the housing lock 21, thereby stabilizing the engagement allowance between the housing lock 21 and the lock protrusion 63, and the engagement force between the housing lock 21 and the lock protrusion 63 can also be increased.

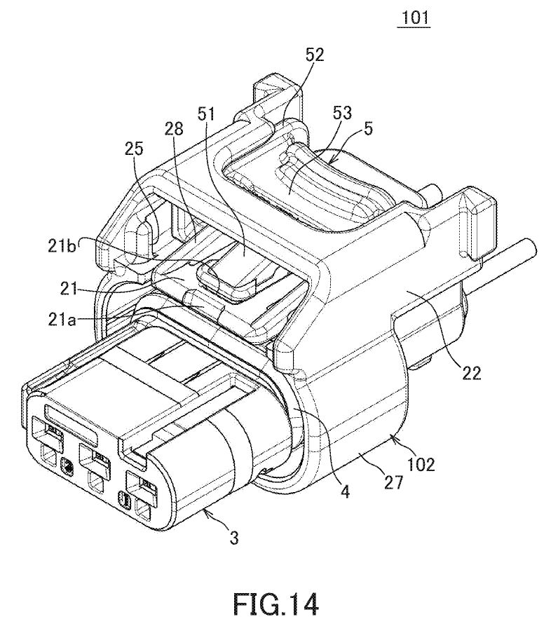

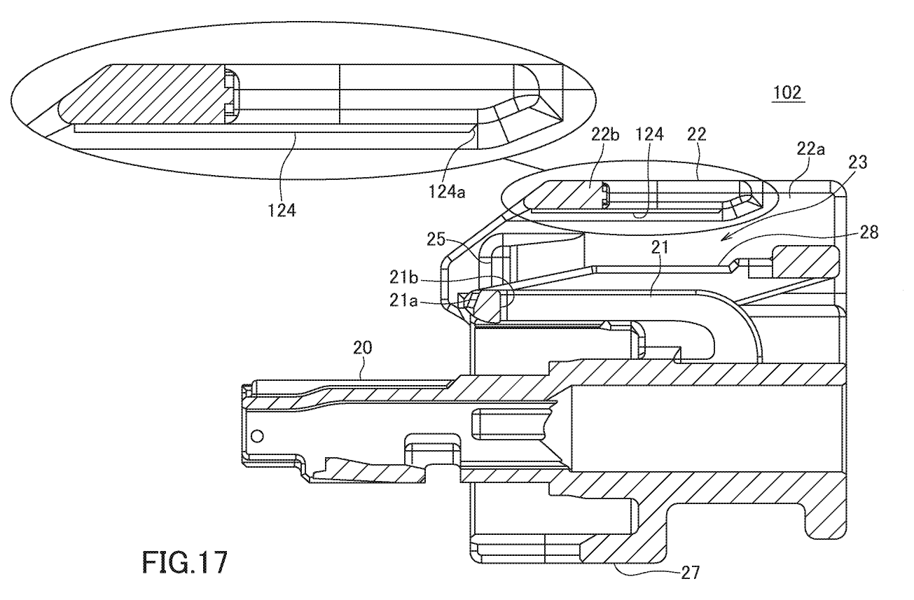

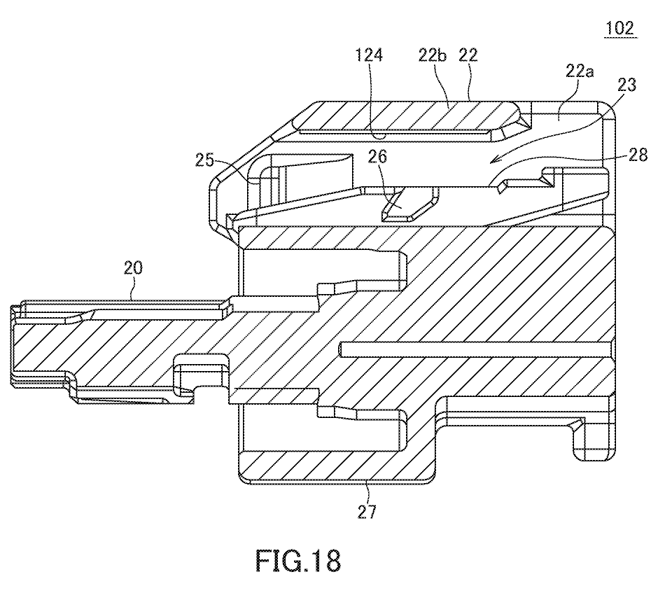

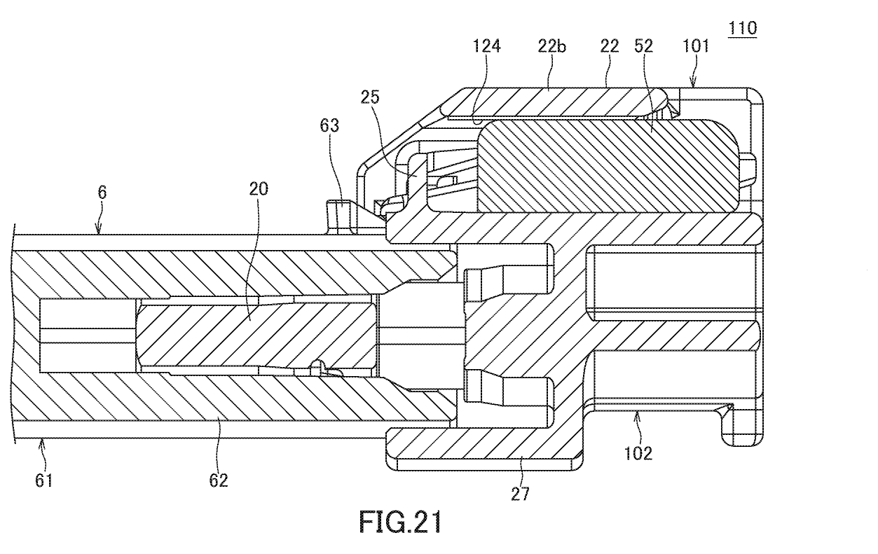

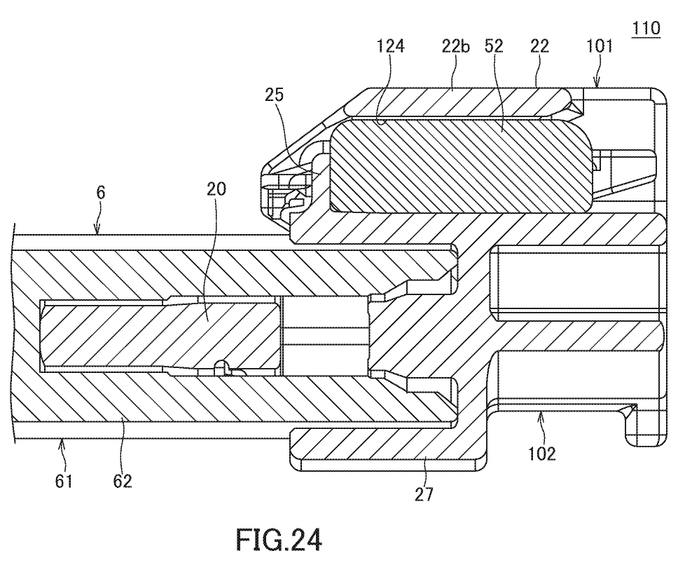

The "connector mating structure" according to the second embodiment of the present invention will be described with reference to FIGS. 14-25. In FIGS. 14-25, the same reference numerals are used for components identical to those of the first embodiment, and detailed description thereof is omitted.

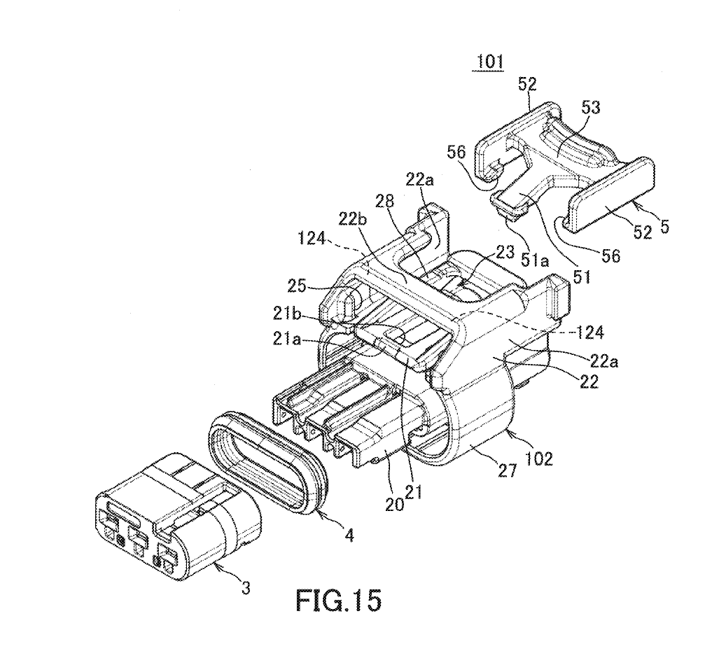

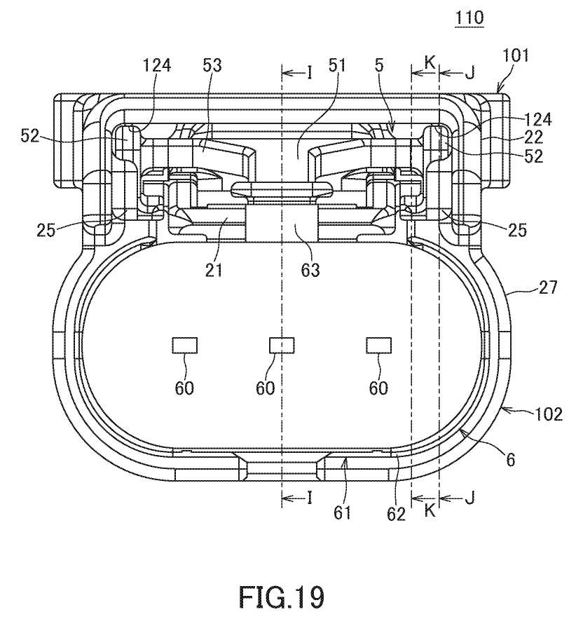

A connector mating structure 110 illustrated in FIGS. 19-25 includes a first connector 101 (illustrated in FIGS. 14-15) and a second connector 6 (illustrated in FIG. 2), which are configured to mate with each other. The second connector 6 has the same configuration as that of the first embodiment.

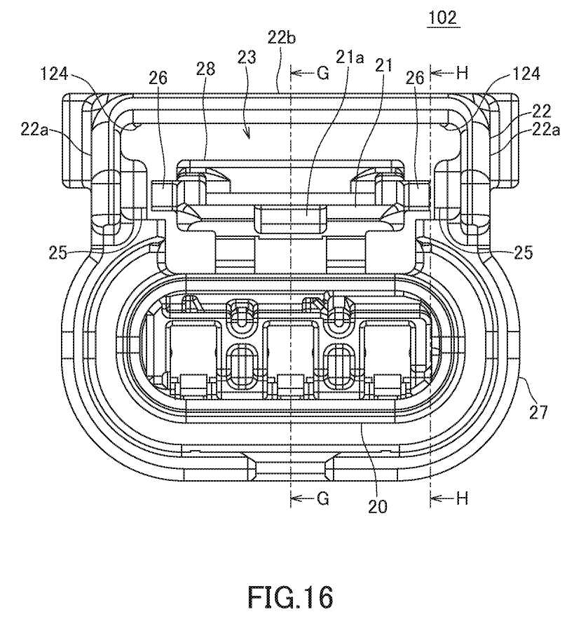

As illustrated in FIGS. 16-18, the first connector 101 has the same configuration as the first connector 1 of the first embodiment, except that pair of ribs 124 provided on the first housing 102 are longer than the pair of ribs 24 of the first embodiment.

The pair of ribs 124 is provided extending from the front end portion to the rear end portion of the upper wall 22b. A tapered portion 124a is formed at the rear end of each rib 124. Due to the tapered portions 124a, when the CPA 5 is attached to the first housing 102, the plate portions 52 can smoothly slide under the ribs 124 without any jamming.

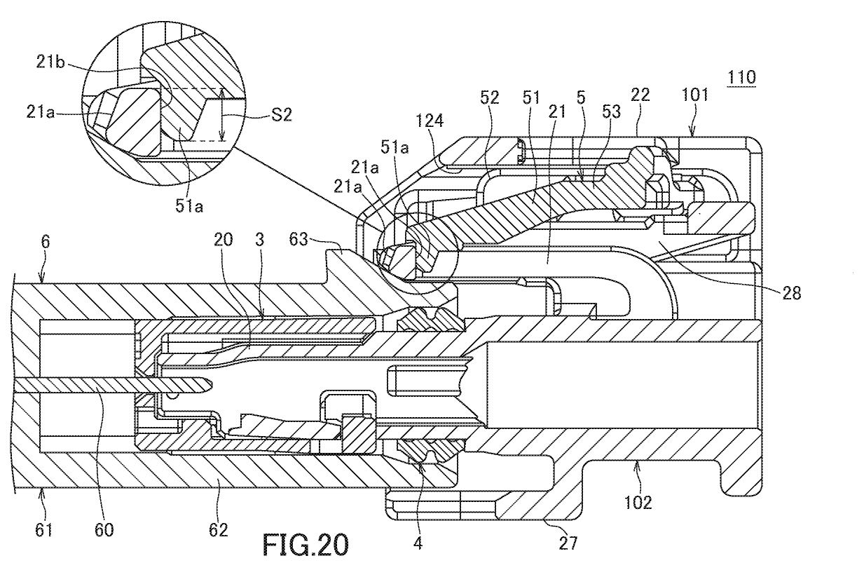

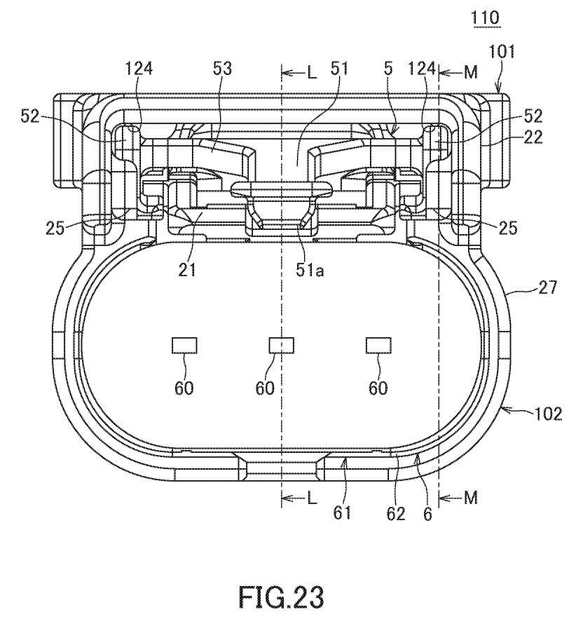

As illustrated in FIGS. 20-22, the pair of ribs 124 press the CPA 5 toward the main body portion 20 from when the CPA 5 is temporarily locked to the first housing 102, that is, before the first connector 101 and the second connector 6 are fully mated. Furthermore, as illustrated in FIGS. 23-25, even when the first connector 101 and the second connector 6 are fully mated and the CPA 5 is positioned in the mating assurance position, the pair of ribs 124 continues to press the CPA 5 toward the main body portion 20.

In this way, the connector mating structure 110 can alleviate looseness in the CPA 5 from before to after the first connector 101 and the second connector 6 are fully mated. Therefore, when the connector mating structure 110 is mounted on a vehicle, it is possible to prevent rattling of the CPA 5 caused by vehicle vibrations, thereby alleviating the generation of abnormal noises.

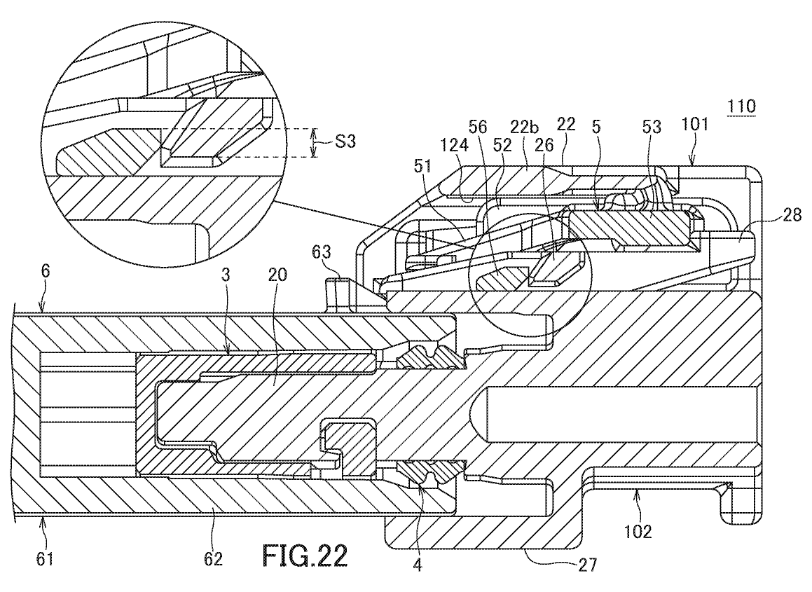

Further, when the CPA 5 is temporarily locked to the first housing 102, the ribs 124 press the plate portions 52 so that the clearance between the CPA 5 and the CPA accommodating portion 23 becomes zero, thereby maintaining the CPA 5 in a parallel state. As a result, an engagement allowance S2 (see FIG. 20) between the arm 51 of the CPA 5 and the housing lock 21, and an engagement allowance S3 (see FIG. 22) between the protrusion 56 of the CPA 5 and the protrusion 26 of the release arm 28, are stabilized. Accordingly, the temporary locking retention force for maintaining the temporarily locked state of the CPA 5 can be increased.

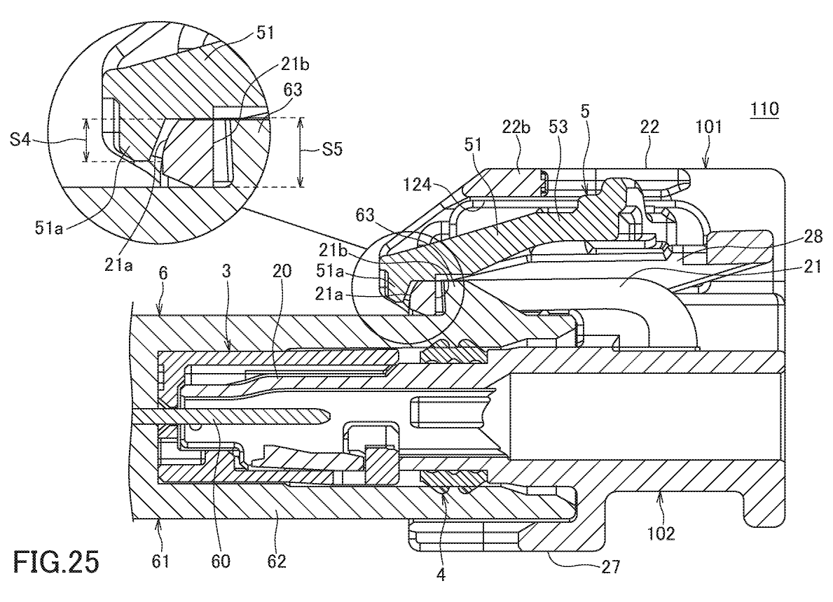

Further, even when the CPA 5 is positioned in the mating assurance position and fully locked to the first housing 102, the ribs 124 press the plate portions 52 so that the clearance between the CPA 5 and the CPA accommodating portion 23 becomes zero, thereby maintaining the CPA 5 in a parallel state. As a result, an engagement allowance S4 (see FIG. 25) between the arm 51 of the CPA 5 and the housing lock 21 is stabilized, and the engagement force between the arm 51 and the housing lock 21 can be increased. Furthermore, since the ribs 124 press the plate portions 52, the arm 51 presses the housing lock 21, thereby stabilizing an engagement allowance S5 (see FIG. 25) between the housing lock 21 and the lock protrusion 63, and the engagement force between the housing lock 21 and the lock protrusion 63 can also be increased.

The embodiments described above merely illustrate representative forms of the present invention, and the present invention is not limited to these embodiments. That is, various modifications and changes may be made without departing from the spirit and scope of the present invention. It is to be understood that such modifications are included within the scope of the present invention so long as they include the essential features of the present invention.

### LIST OF REFERENCE SIGNS

1, 101 first connector
2, 102 first housing
5 CPA (mating assurance member)
6 second connector
10, 110 connector mating structure
20 main body portion
21 housing lock
22 lock protection portion
24, 124 ribs

1. A connector mating structure comprising:
a first connector and a second connector configured to mate with each other,
wherein the first connector includes:
a first housing; and
a mating assurance member that is configured to be attached to the first housing, the mating assurance member being immovable before completion of mating between the first connector and the second connector, the mating assurance member being movable forward after completion of the mating,
wherein the first housing includes:
a main body portion accommodating terminals;
a housing lock that extends cantilevered forward from an upper surface of the main body portion; and
a lock protection portion including a pair of side walls arranged on left and right sides of the housing lock and an upper wall that positions the housing lock between the upper wall and the main body portion,
wherein the mating assurance member is accommodated between the pair of side walls and between the upper wall and the housing lock,
the housing lock is configured to lock to the second connector having mated with the first connector and to the mating assurance member having moved forward,
a rib extending in a front-and-rear direction, which is a movement direction of the mating assurance member, is provided on the upper wall, and
when the mating assurance member has moved forward and has locked to the housing lock, the rib presses the mating assurance member toward the main body portion.

2. The connector mating structure according to claim 1, wherein a tapered portion is formed at a rear end of the rib.

3. The connector mating structure according to claim 1, wherein the rib does not contact the mating assurance member before completion of mating between the first connector and the second connector, and comes into contact with the mating assurance member when the mating assurance member moves forward after completion of the mating.

4. The connector mating structure according to claim 1, wherein the rib applies pressure to the mating assurance member toward the main body portion even before completion of mating between the first connector and the second connector.

5. The connector mating structure according to claim 1,
wherein the housing lock is formed in a frame shape with an opening,
the mating assurance member includes:
a pair of plate portions arranged on both the left and right sides of the housing lock;
a connecting portion that links the pair of plate portions; and
an arm that extends cantilevered forward from the connecting portion,
before completion of mating between the first connector and the second connector, a tip of the arm is positioned within the opening of the housing lock, preventing forward movement of the mating assurance member, and after completion of the mating, the mating assurance member moves forward and the arm locks to the tip of the housing lock.

6. The connector mating structure according to claim 5,
wherein a pair of ribs is provided on the upper wall, and
when the mating assurance member is moved forward and locked to the housing lock, the pair of ribs presses the pair of plate portions toward the main body portion.
